(19) United States
(12) Patent Application Publication
(10) Pub. No.: US 2002/0165877 A1
(43) Pub. Date: Nov. 7, 2002

(54) Method and apparatus for filling out electronic forms

(76) Inventors: Jerry Walter Malcolm, Austin, TX (US); Newton James Smith JR., Austin, TX (US)

Correspondence Address: Rudolf O. Siegesmund, Suite 2000, 4627 N. Central Expressway, Dallas, TX, 75205-4022, US

(21) Appl. No.: 09/731,651

(22) Filed: Dec. 7, 2000

(51) Int. Cl. G06F 15/00

(52) U.S. Cl. 707/507

(57) ABSTRACT

A standard based automated system is disclosed for filling out electronic forms based on a standard. A user creates a standard compliant database with labeled fields for name(s), address(s), telephone number(s), credit card number(s), and other information. A requester creates a standard compliant form and sends the form to the user where the form extracts information from the appropriate fields of the database. The user also creates a set of rules for combining the standard compliant database with the standard compliant form by applying a set of rules for default values, a set of rules responsive to flags included in the form, and a set of rules to make certain decisions when conflicts arise among field values. The completed form is then presented to the user for approval and returned to the information requester.

### TECHNICAL FIELD

This invention relates to an apparatus and method for filling in electronic forms, and specifically to a standard based automated system having a standard compliant form for extracting information from appropriate fields of a standard compliant database and inserting the information into the standard compliant form.

### BACKGROUND OF THE INVENTION

Exchange of information between computers in an electronic communication system is now commonplace. Users of e-commerce via the Internet often encounter situations where forms are required to be completed. Electronic commerce involves commercial activities between businesses, as well as between consumers and businesses that involve electronic media operating under a standard payment platform, such as electronic payment systems and online banking systems (e.g., Secure Electronic Transaction SET, Open Financial Exchange OFX, etc.). A user at a terminal connected to the electronic communications system often has to repeat certain actions, such as entering personal information. For example, in an Internet electronic commerce situation, a user often has to fill in forms to order merchandise, to register products for warranty claims, to request services, or for a wide variety of other purposes. The forms are displayed on a computer screen via a web page. The information in most of these forms is similar, such as name, address, telephone number and credit card number. The user enters alphanumeric text into the form displayed on a computer monitor via an input device such as a keyboard each and every time the information is required. A need exists for a way to automate the entry of information that is required so that the user does not have to enter the alphanumeric text each time the information is required.

Merchants seek information to be recorded into proprietary forms (databases or electronic forms) by entry of data into predetermined fields which have been communicated to a particular customer through a web page. The predetermined fields vary from web page to web page, and at present there is no motivation among those requesting information to standardize their forms. For example, Amazon.com stores user information and fills in most of its order form to automate much of the sales transaction. However, each merchant manages this process independently, and a system that works for one merchant and one customer, may not work for that same customer and a different merchant.

Therefore, a need exists for a form that can be used by an information requester so that the form can access a user's personal database. A family may use a home computer and the Internet to engage in a variety of transactions. The family may have several banks accounts and several credit cards, some of which are in the name of one spouse and some in the name of the other spouse. In addition, either or both spouses may have a business credit card to be used for certain transactions. If either or both spouses are professionals, they may have annual forms to update requiring entry of certain professional information and identification numbers to professional societies or state agencies. It may be desirable for each spouse to use different payment methods or different credit cards for various transactions. For example, the husband may buy a set of skis for personal use, and enter the requested information by filling in an electronic form that includes a field entry for his personal credit card number. Later, the husband may order a wireless phone system for his business, and desire to use his business credit card. On another occasion, an electronic bill may be sent from a department store that is to be charged to the wife's credit card. Therefore, different data is needed for each transaction. Moreover, the ability to distinguish among the various transactions and among the various data required for each transaction is a needed prerequisite for such an automated system.

U.S. Pat. No. 6,065,048, entitled “Method and System to Create, Transmit, Receive and Process Information, Including an Address to Further Information,” describes a method and system for sending and receiving Uniform Resource Locators (URLs) in electronic mail over the Internet. U.S. Pat. No. 6,004,205 entitled, “Communication System for Transferring Information Between Memories According to Processes Transferred with the Information,” describes an automated communications system that operates to transfer data, metadata and methods from a provider computer to a consumer computer through a communications network. U.S. Pat. No. 6,026,410, entitled “Information Organization and Collaboration Tool for Processing Notes and Action Requests in Computer Systems,” describes a natural language-based information organization and collaboration tool for a computer system. U.S. Pat. No. 6,018,761, entitled “System for Adding to Electronic Mail Messages Information Obtained From Sources External to the Electronic Mail Transport Process,” discloses an apparatus and method for obtaining message context information regardless of whether or not the sender includes context information, such as a full name, address or telephone number. U.S. Pat. No. 6,012,083, entitled “Method and Apparatus for Document Processing Using Agents to Process Transactions Created Based on Document Content,” discloses a Web agency being interposed between a Web client and a Web server to transform the requests from the Web client prior to sending the requests to the Web server, as well as other steps or structures as described by said patent.

What is needed beyond the prior art is a way to automate the insertion of requested information into a variety of web based forms. What is further needed is a way for accomplishing the automatic insertion of data while distinguishing the nature of requests according to a pre-selected set of rules and default values.

### SUMMARY OF THE INVENTION

The invention which meets the needs identified above is a standard based automated system for filling out electronic forms using a standard compliant form accessible to merchants that allows data to be extracted from labeled fields in a user's standard compliant database. A user creates a standard compliant database with labeled fields for name(s), address(s), telephone number(s), credit card number(s), and other information. A requester creates a standard compliant form and sends the form to the user where the form extracts information from the appropriate fields of the database. The user also creates a set of rules for combining the standard compliant database with the standard compliant form by applying a set of rules for default values, a set of rules responsive to flags included in the form, and a set of rules to make certain decisions when conflicts arise among field values. The completed form is then presented to the user for approval and returned to the information requester.

### BRIEF DESCRIPTION OF THE DRAWINGS

The present invention will now be described, by way of example, with reference to the accompanying drawings, in which:

FIG. 1 is a schematic of the form and database;

FIG. 2 is a schematic depicting the operation of the form and database;

FIG. 3 is a flowchart describing the present invention;

FIG. 4 depicts a flowchart describing the process of creating or updating the database.

### DESCRIPTION OF THE PREFERRED EMBODIMENT

Referring to FIG. 1, automated process 100 has form 104 and database 102 that are compliant with a standard. As used herein, the term compliant means adhering to a standard. As used herein, the term standard means a protocol extension which specifies the fields which may be used in the forms and in the corresponding user database. As used herein, the term establishing means defining the fields in the protocol extension by which a requester may construct a form, by which a user may construct a database, and by which the requester and the user may transfer field values over a network using the form and database. As used herein, the term protocol extension includes but is not limited to the MIME protocol extension. In the preferred embodiment of automated process 100 and of the related methods and processes disclosed herein, the standard is the MIME protocol extension. As used herein, MIME stands for Multipurpose Internet Mail Extensions and is an existing specification for formatting non-ASCII messages so that they can be sent over the Internet. Most browsers now support MIME, which enables them to send and receive graphics, audio, and video files via the Internet mail system. In addition, MIME supports messages in character sets other than ASCII. There are many predefined MIME types, such as GIF graphics files and PostScript files. It is also possible for the user to define MIME types. This enables the browser to display or output files that are not in HTML format. MIME was defined in 1992 by the Internet Engineering Task Force (IETF). A version called S/MIME supports encrypted messages. The scope of the present invention is not limited to the MIME protocol. Any standard that can transfer field values via a network may be selected for automated process 100. Thus, it does not matter whether the field values are contained within or attached to an email, as long as the field values are acceptably transferred to a requester. Form 104 is created by requester 120 and sent to the user. Form 104 may contain flag 105. As used herein, the term flag means a variable indicating the existence or status of a certain condition. Automated process 100 combines form 104 and database 102 by applying rules 106 to produce completed form 108 which is then transmitted in network 110 to requester 120. Database 102 is adapted for entry of information into labeled fields. Database 102 and completed form 108 may be encrypted. In the preferred embodiment, completed form 108 will be encrypted prior to transmission to requester 120. Database 102 may be located within a user's computer, or alternatively, database 102 may be in a separate location such as a proxy server. Information for each labeled field may be divisible. In other words, several instances of data may be present in each field of database 102. For example, a “name” field may be further subdivided into “company name,” “user's legal name,” and “spouse's name”. However, when multiple entries are available in a field, a default entry may be identified by one of the rules contained in rules 106.

Information requester 120 creates form 104. Requester 120 may send form 104 to a user through a web page, e-mail or by other electronic transmission. Form 104 queries database 102 to extract data from the labeled fields in order to fill out the form. Flag 105 may indicate whether the request is personal, business or related to a particular family member. Flag 105 may be further adapted by requester 120 to simplify the task of the user in creating rules 106. Rules 106 are created by the user and applied to determine which of the several values will be entered into the form. Rules 106 may include a set of rules for default values, a set of rules responsive to flag 105 included in the form, and a set of rules to make certain decisions when conflicts arise. The user may also override rules 106 by intervention through a pull-down list box or other graphical user interface (GUI). Based upon the field values selected by the user, rules 106 may then specify a value for one or more of the other fields. For example, if “company name” is selected for the name field, “company address” is inserted into the address field, and “company credit card” is inserted into the credit card field.

Database 102 contains data which has been previously entered. Form 104 is capable of having data written to it from database 102. In order for a portion of the data within database 102 to be written into form 104 according to the user's preference, rules 106 are selectively applied upon form 104 and database 102. Form 104 and the portion of user data selected from database 102 by application of rules 106 and by user selection merge into completed form 108. After review by the user, completed form 108 is encrypted by encryption program 109 and transmitted in network 110 to requester 120. Network 110 is capable of communication to information requester 120. Automated process 100 may be embodied in the form of computer program code containing instructions embodied in tangible media, such as floppy diskettes, CD-ROMs, EPROMs, hard drives, or any other computer-readable storage medium, wherein, when the computer program code is loaded into and executed by a computer, the computer becomes an apparatus for practicing the invention. Automated process 100 can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits. Network 110 can be a local area network (LAN), or network 110 may be a wide area network (WAN) such as the World Wide Web (WWW) of the Internet. Form 104 can reside in close proximity to database 102. Or, alternatively, form 104 can reside apart from database 102. In other words, a network (not shown) may exist between form 104 and database 102. For example, form 104 may reside in a server (not shown) serving database 102.

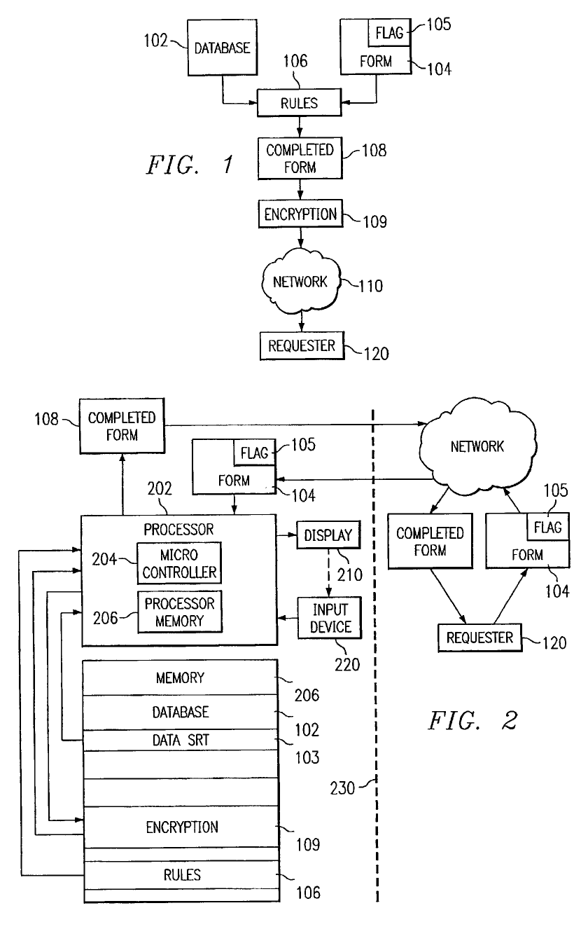

FIG. 2 depicts communication system 200. Form 104, database 102 and rules 106 reside within memory 206. In the alternative, rules 106 may reside in processor memory 206, or in any other suitable location. Memory 206 may be RAM, ROM, (CDROM, EPROM, etc.), or any suitable type of memory. In response to form 104, data set 103 flows from database 102 to processor 202 wherein micro-controller 204 controls a processing operation. Processor 202 includes micro-controller 204 and processor memory 206. Rules 106, or at least part of rules 106, flow to processor 202. Processor 202 is coupled to display device 210 such as a monitor. Display device 210 may also be coupled to input device 220. Input device 220 is coupled to processor 202. Processor 202 is further coupled to network 110 so that completed form 108 may be encrypted by encryption program 109 and transmitted out of boundary 230. Boundary 230 may be a firewall. As used herein, firewall means a combination of hardware and software that prevents computers in a network from communicating directly with computers external to the network and vice versa. Instead, all communication is routed through a proxy server outside of the network, and the proxy server decides whether it is safe to let a particular message or file pass through to the network. In the preferred embodiment, information transmitted within and without boundary 230 is suitably encrypted; however, automated process 100 can operate without encryption. In turn, completed form 108 is encrypted by encryption program 109 and transmitted in network 110 to information requester 120.

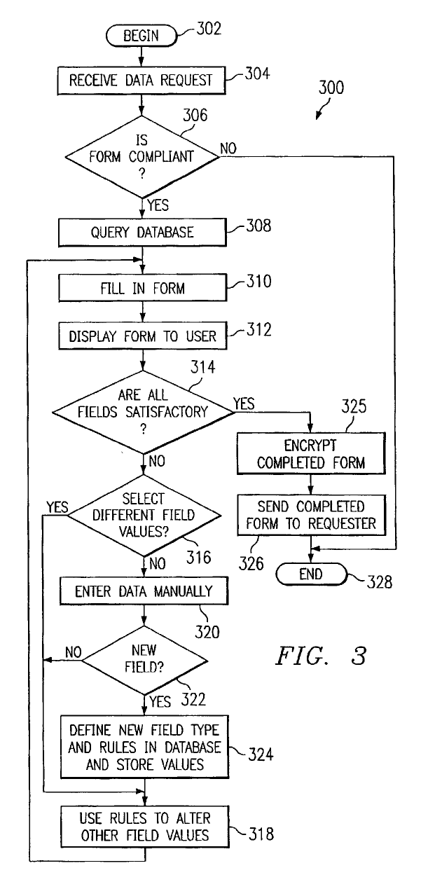

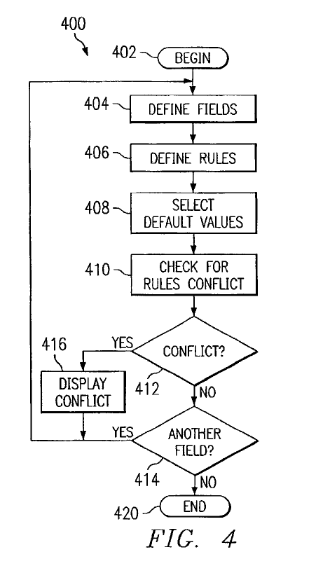

FIG. 3 depicts a flow chart of automated database process 300. Referring to FIG. 2 and FIG. 3, a user (not shown) having access to components within boundary 230 desires to order merchandise (also not shown) from a seller (not shown) who has access to requester 120 for an electronic commerce (e-commerce) transaction, or its equivalent. Requester 120 needs related data from the user. The data needed by requester 120 may include information such as name, address, phone number, credit card number or other information that may be transmitted in form 104. Form 104 is received at the user's computer (304). After form 104 is received, a determination is made as to whether any portion of form 104 is compliant (306). If no portion of form 104 is compliant, the process ends (328). If any portion of form 104 is compliant, database 102 is queried (308). Processor 202 invokes form 104, database 102 and rules 106 to fill in all fields in form 104 that can be filled in (310). Completed form 108 (see FIG. 2) is transmitted to display device 210, that may be a monitor, and completed form 108 is displayed to the user (312). Next a determination is made as to whether all of the fields in completed form 108 have been filled in satisfactorily (314). If all of the fields have been filled in satisfactorily, completed form 108 is encrypted (325) and sent to information requester 120 (326). If all of the fields in completed form 108 have not been filled in satisfactorily (314), a determination is made whether to select a different field value (316). If a determination is made to select a different field value (316), then rules 106 are used to alter the other field values (318) and automated process 100 fills in completed form 108 with the new values (310) and displays completed form 108 to the user (312). For example, if the name field consists of the husband's name as well as another family member's name, all or some of the field values are displayed. In the preferred embodiment, a drop down menu would be displayed and one of the field values chosen. The selection of different field values may occur automatically; alternatively, the selection of different field values may occur non-automatically with manual human intervention, such as by a click of a mouse device.

If a determination is made not to select a different field value, the data is entered manually (320). After the data is entered manually, a determination is made whether a new field has been identified (322). A new field type may be identified if requester 120 sends form 104 containing a previously unidentified request. If a new field type has not been identified, the process goes to step 318, rules 106 are used to alter other field values, and the process goes to step 310. If a new field type has been identified, new field values are defined, new rules for the new field values are defined, the new field values and new rules are stored (324), and the process goes to step 318.

A change of a default value (326) may cause a change in other field values. For example, if the user name field is changed from the user's legal name to a “doing business as” (DBA) name, the user's personal credit card number is changed to the user's business credit card number. Appropriate rules specify the change of default values. Alternatively, the change can be achieved by using list boxes, or pull down menus. Furthermore, every field may have a “none” option if the user did not want to supply that information. In addition, there may be a set of user/requester defined fields for special information for which there would not be a standard field. For fields that had to be filled in manually, such as a “problem description” field, the related information may be stored in the user database so that it is available for selection in the future. As appropriate, list boxes may have access to the manually stored values. The user may review the default values, which had been automatically placed into the form, make any necessary changes, and authorize the release of the information back to the requester as completed form 108 (326).

FIG. 4 depicts the process for creating database 102. The process begins (402) and fields are defined (404). The information within the database may be in the form of different fields, each field having a value or a set of values. Each field may have several instances of data such as: company name, user's name and spouse's name; business address and personal address; and multiple credit card numbers. For example, the field of the user name may be the husband's name or other family member's name. Furthermore, a default value may be defined such that the default value is the name of the wife. In addition, the default value may be blank or zero when the user does not want to automatically assign a value, when the value can be added at a later time, or when the value needs to be entered manually. Rules are defined (406) in order to make pre-selected decisions when there are several instances of data in a field. For example, if an information request is received from an office supply company, the form will indicate the user's business information is to be selected. The form may include flag 105 (See FIGS. 1 and 2) to indicate which of the defaults should be used. For example, flag 105 may indicate either personal, family or business, and the user, having previously established a rule that if flag 105 indicates a business request, the rule will specify the business field values. If the form indicates a personal request, the user can still override if the user desires to use business field values. For an information request from a department store, the user defines a rule to select the user's personal credit card, or if married, the rule may specify the user's spouse's credit card. Other default values are also selected (408). The default values are the values that will automatically be entered unless there is a choice among several instances of data in which the rules will be applied to make a selection. A check is made to see if there is a conflict in the rules (410). A conflict in the rules occurs when the values that have been selected by the user or rules 106 (FIGS. 1 and 2) preclude a determination of values for one or more data fields for entry in form 104 in order to create completed form 108 (FIGS. 1 and 2). If there is a conflict in the rules (412) the conflict is displayed (416). The user may then resolve the conflict by re-defining the fields to eliminate the conflict (404) and the process will continue to step 406. If there are other fields to be defined (414) the process will return to step 404. If there are no other fields to be defined, the process ends (420). The data may then be encrypted for protection.

The present invention can be embodied in the form of computer-implemented processes and apparatuses for practicing those processes. It will be understood that a person skilled in the art may make modifications to the preferred embodiment shown herein within the scope and intent of the claims. While the present invention has been described as carried out in a specific embodiment thereof, it is not intended to be limited thereby but intended to cover the invention broadly within the scope and spirit of the claims.

What is claimed is:

1. A method for filling out electronic forms comprising:
establishing a standard specifying pre-defined fields;
providing a standard complaint form made up of a plurality of subsets of said pre-defined fields;
providing a standard compliant database having a multiplicity of field values;
providing a set of rules;
responsive to said rules, combining one or more field values and said pre-defined fields in a completed form.

2. The method of claim 1 further comprising the step of:
responsive to application of a rule from said set of rules and selection of a value in a certain field by the user, changing values in other related fields.

3. The method of claim 1 further comprising receiving said standard compliant form from said requester.

4. The method of claim 1 further comprising providing a network as a conduit for receiving said standard compliant form.

5. The method of claim 1 further comprising transmitting said completed form in a network.

6. The method of claim 1 further comprising;
displaying a set of requested field values for a requested field of said standard compliant form; and
selecting one of said set of requested field values from the standard compliant database.

7. The method of claim 1 further comprising:
providing a set of rules responsive to flags included in the standard compliant form.

8. The method of claim 1 further comprising:
providing a set of rules to apply when conflicts arise among field values.

9. The method of claim 1 further comprising transmitting said completed form to said requester.

10. The method of claim 1 further comprising providing a flag in said form.

11. The method of claim 1 further comprising determining whether a field value combined in said completed form is acceptable.

12. A computer implemented process to accomplish automatic insertion of data from a database into a completed form received from a network comprising:
establishing a standard;
creating a standard compliant form having a predetermined set of fields;
creating a database having a multiplicity of field values for filling out said fields;
creating a set of rules; and
combining said standard compliant form with a subset of said multiplicity of field values;
wherein a completed form is created.

13. The computer implemented process of claim 12 further comprising:
responsive to application of a rule from said set of rules and selection of a value in a certain field by a user, changing values in other related fields.

14. The computer implemented process of claim 12 further comprising:
receiving said standard compliant form from said requester.

15. The computer implemented process of claim 12 further comprising:
creating a set of rules responsive to flags included in the standard compliant form.

16. The computer implemented process of claim 12 further comprising:
creating a set of rules to apply when conflicts arise among field values.

17. The computer implemented process of claim 12 further comprising:
providing a network as a conduit for receiving said standard compliant form.

18. The computer implemented process of claim 12 further comprising:
transmitting said completed form in a network.

19. The computer implemented process of claim 12 further comprising:
displaying a set of requested field values for a requested field of said standard compliant form;
selecting one of said set of requested field values; and
changing at least one other field value associated with a field of said standard compliant form.

20. The computer implemented process of claim 12 further comprising:
determining whether the field value filled out in said completed form is acceptable.

21. The computer implemented process of claim 12 further comprising:
receiving said completed form by a requester.

22. A communication system for filling out an electronic form based on an established standard comprising:
a set of storage devices including a standard compliant database having multiplicity of field values;
a standard compliant form received from a requester; and
a controller coupled to said set of storage devices for combining a subset of said multiplicity of field values with said received standard compliant form.

23. The communication system of claim 22 further comprising a display device coupled to said controller.

24. The communication system of claim 22 further comprising an input device coupled to said controller and to said display device for entering a value whereby different field values may be entered into said standard compliant form.

25. The communication system of claim 22 further comprising a set of rules for combining said subset of said multiplicity of field values with said standard compliant form.
